(19) United States
(12) Patent Application Publication
(10) Pub. No.: US 2024/0297300 A1
(43) Pub. Date: Sep. 5, 2024

(54) ACTIVE MATERIAL COMPOSITE AND SECONDARY BATTERY

(71) Applicant: TOYOTA JIDOSHA KABUSHIKII KAISHA, Toyota-shi Aichi-ken (JP)

(72) Inventors: Masaru Kubota, Okazaki-shi Aichi-ken (JP); Kazushige Nomoto, Sunto-gun Shizuoka-ken (JP)

(73) Assignee: TOYOTA JIDOSHA KABUSHIKII KAISHA, Toyota-shi Aichi-ken (JP)

(21) Appl. No.: 18/590,442

(22) Filed: Feb. 28, 2024

(30) Foreign Application Priority Data
Mar. 1, 2023 (JP) 2023-031327

(51) Int. Cl. H01M 4/36; H01M 4/02; H01M 4/505; H01M 4/525

(52) U.S. Cl. CPC H01M 4/366; H01M 4/505; H01M 4/525; H01M 2004/028

(57) ABSTRACT

An active material composite having durability after a cycle test is disclosed. The active material composite of the present disclosure has an active material particle and a coating layer, wherein the coating layer covers at least a portion of the surface of the active material particle, the coating layer contains a phosphoric acid compound, and elements constituting the coating layer contain C and F.

### CROSS-REFERENCE TO RELATED APPLICATIONS

This application claims priority to Japanese Patent Application No. 2023-031327 filed Mar. 1, 2023, the entire contents of which are herein incorporated by reference.

### FIELD

The present application discloses an active material composite and a secondary battery.

### BACKGROUND

A technique is known in which a coating layer is formed on a surface of active material particles to obtain an active material composite. For example, PTL 1 discloses a positive electrode material having a positive electrode active material exhibiting strong basicity and a coat layer covering the surface of the positive electrode active material and including a polyanion structure exhibiting acidic. PTL 2 discloses a technique for introducing a halogen when a surface of a lithium-containing composite oxide particle is coated with a compound containing Li, A and O (A is one or more elements selected from the group consisting of Ti, Zr, Ta, Nb, Zn, W and Al).

### CITATION LIST

### Patent Literature

[PTL1] JP 2012-099323 A

[PTL 2] WO 2019/035418 A

### SUMMARY

### Technical Problem

Conventional active material composites have room for improvement in terms of resistance increase rate after cycle testing.

### Solution to Problem

The present application discloses the following plurality of aspects for solution to the above problem.

### <Aspect 1>

An active material composite comprising an active material particle and a coating layer, wherein
the coating layer covers at least a portion of the surface of the active material particle,
the coating layer comprises a phosphoric acid compound, and
elements constituting the coating layer comprise C and F.

### <Aspect 2>

The active material composite according to Aspect 1, wherein
the phosphoric acid compound comprises one or both of Li and B.

### <Aspect 3>

The active material composite according to Aspect 1 or 2, wherein the coating layer comprises a C—F bond.

### <Aspect 4>

The active material composite according to any one Aspects 1 to 3, wherein the coating layer comprises NaF.

### <Aspect 5>

A secondary battery comprising: a positive electrode active material layer, an electrolyte layer and a negative electrode active material layer, wherein
the positive electrode active material layer comprises the active material composite according to any of Aspects 1 to 4.

### EFFECTS

The active material composite of the present disclosure has a small resistance increase rate after the cycle test.

### BRIEF DESCRIPTION OF DRAWINGS

FIG. 1 schematically shows an example of the shape of the cross section of the active material composite.

FIG. 2A shows an example of the flow of the method for producing an active material composite (first embodiment)

FIG. 2B shows an example of the flow of the method for producing an active material composite (first embodiment).

FIG. 3A shows an example of the flow of the method for producing an active material composite (second embodiment).

FIG. 3B shows an example of the flow of the method for producing an active material composite (second embodiment).

FIG. 4 schematically shows an example of the configuration of the secondary battery.

### DESCRIPTION OF EMBODIMENTS

### 1. Active Material Composite

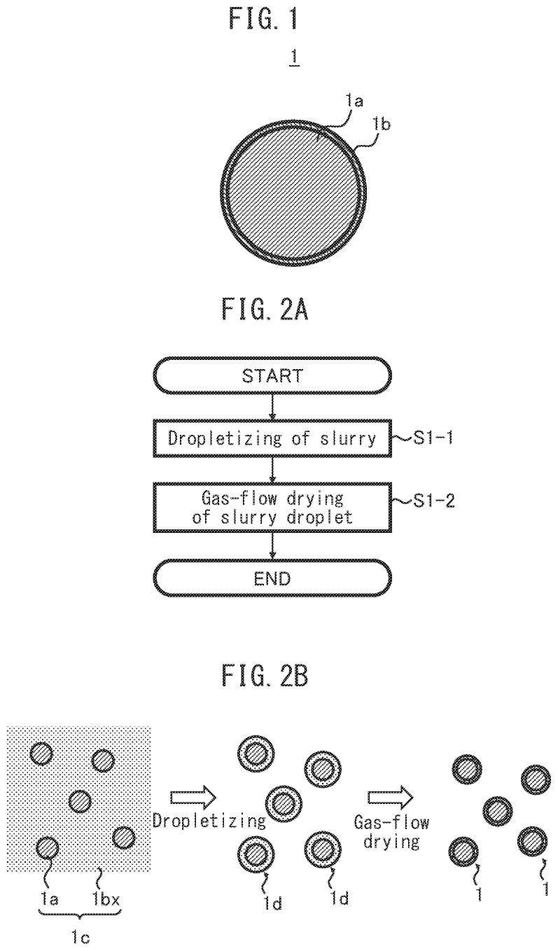

FIG. 1 schematically shows a cross-sectional structure of an active material composite according to an embodiment. As shown in FIG. 1, the active material composite 1 has an active material particle 1a and a coating layer 1b. The coating layer 1b covers at least a part of the surface of the active material particle 1a. The coating layer 1b comprises a phosphoric acid compound. Elements constituting the coating layer 1b comprises C and F.

### 1.1 Active Material Particle

The active material particle 1a may be a positive electrode active material particle or a negative electrode active material particle. In particular, when the active material particle 1a is a positive electrode active material particle, a higher effect is exhibited.

### 1.1.1 Active Material

The active material constituting the active material particle 1a may be at least one selected from, for example, a lithium-containing compound; a sulfur-based active material such as a single substance sulfur and a sulfur compound; a Si-based active material such as Si and a Si alloy; a carbon-based active material such as graphite and hard carbon; a metallic lithium and a lithium alloy; and the like. In particular, when the active material particle 1a contains a lithium-containing compound, a higher effect is exhibited. Only one kind of active material may be used alone, or two or more kinds thereof may be used in combination.

The lithium-containing compound as an active material may be a lithium-containing oxide containing at least one elements M, Li, and O. The element M may be, for example, at least one of Mn, Ni, Co, Al, Mg, Ca, Sc, V, Cr, Cu, Zn, Ga, Ge, Y, Zr, Sn, Sb, W, Pb, Bi, Fe and Ti, or may be at least one of Mn, Ni, Co, Al, Fe and Ti. More specifically, the lithium-containing oxide may be at least one of lithium cobaltate, lithium nickelate, lithium manganate, lithium nickel cobaltate, lithium nickel manganate, lithium cobalt manganate, lithium nickel cobalt manganate (Li_{1±α}NiₓCo_{y}Mn_{z}O_{2±δ} (e.g., 0<x<1, 0<y<1, 0<z<1, x+y+z=1)), a spinel-based lithium compound (such as a heterogeneous element substituted Li—Mn spinel having a composition represented by Li₁₊ₓMn_{2-x-y}M_{y}O₄ (M is one or more selected from Al, Mg, Co, Fe, Ni and Zn)), lithium nickel cobalt aluminate (e.g., Li_{1±α}NiₚCo_{q}AlᵣO_{2±δ} (p+q+r=1), lithium titanate, lithium metal phosphate (e.g., LiMPO₄ wherein M is one or more selected from Fe, Mn, Co, and Ni) and the like. In particular, when the active material particle contains lithium containing oxide having at least one of Ni, Co and Mn; Li; and O as a constituent element, higher performance is obtained. Alternatively, even when the active material particle contains a lithium-containing oxide having at least one of Ni, Co and Al; Li; and O as constituent elements, higher performance is obtained.

### 1.1.2 Particle Shape

The active material particle may be a solid particle, may be a hollow particle, or may be a particle having voids. The active material particle may be primary particle or secondary particle in which a plurality of primary particles are aggregated. The mean particle diameter (D50) of the active material particles may be, for example, 1 nm or more and 500 μm or less. The lower limit may be 5 nm or more or 10 nm or more, and the upper limit may be 100 μm or less, 50 μm or less, or 30 μm or less. In the present application, the mean particle diameter D50 is the particle diameter (median diameter) at an integrated value of 50% in the particle size distribution on a volume basis determined by a laser diffraction/scattering method.

### 1.2 Coating Layer

The coating layer 1b covers at least a part of the surface of the active material particle 1a. At least a part of the surface of the active material particle 1a is coated by the coating layer 1b, so that an unfavorable chemical reaction at an interface between the active material composite 1 and another material (e.g., a sulfide solid electrolyte) hardly occurs, and deterioration of the active material composite 1 is suppressed.

### 1.2.1 Component Contained in the Coating-Layer 1b: a Phosphoric Acid Compound

The coating-layer 1b includes a phosphoric acid compound (phosphate). A phosphoric acid compound is a compound containing P and O. The phosphoric acid compound contained in the coating layer 1b may be, for example, one or both of Li and B. In other words, the phosphoric acid compound may be, for example, a compound containing Li, P and O, a compound containing B, P and O, or a compound containing Li, B, P and O. When the phosphoric acid compound contained in the coating-layer 1b contains one or both of Li and B, the active material composite 1 has more durability. Whether or not the coating layer 1b contains a phosphoric acid compound can be confirmed, for example, by XPS, SEM-EDX, or the like. For example, the active material composite 1 may be one in which a peak derived from P and O is confirmed when the surface thereof is analyzed by XPS. Alternatively, the active material composite 1 may be one in which P and O is confirmed when the surface thereof is subjected to elemental analysis by SEM-EDX or the like.

### 1.2.2 Other Constituent Element Contained in the Coating Layer 1b: C and F

The coating layer 1b, as constituent elements, contains C and F. C and F may or may not be chemically bonded to each other. In addition, C and F may be included in the form of a compound. According to the findings of the present inventor, when the coating layer 1b contains C and F together with the above-described phosphoric acid compound, the coating layer 1b is hardly decomposed even at a high potential, and the durability of the coating layer 1b is improved. Whether or not the elements constituting the coating layer 1b contain C and F can be confirmed by, for example, XPS or SEM-EDX. For example, the active material composite 1 may be one in which a peak derived from C and F is confirmed when the surface thereof is analyzed by XPS. Alternatively, the active material composite 1 may be one in which C and F is confirmed when the surface thereof is subjected to elemental analysis by SEM-EDX or the like.

The coating-layer 1b may have a C—F bond, whereby the durability of the coating-layer 1b is more improved. Whether or not the coating layer 1b has a C—F bond can be confirmed, for example, by X-ray photoelectric spectroscopy (XPS). For example, the active material composite 1 may be one in which a peak derived from a CFₓ is confirmed when the surface thereof is analyzed by XPS.

### 1.2.3 C and F Sources

C and F as constituent elements contained in the coating layer 1b may be those derived from a fluoro compound. For example, C and F as constituent elements contained in the coating layer 1b may be those derived from perfluoropolyether (PFPE). Since the perfluoropolyether has an ether bond, it is considered that the perfluoropolyether has a higher affinity for the active material particle 1a and the coating layer 1b. In addition, it is considered that the perfluoropolyether has low reactivity to other materials (e.g., sulfide solid electrolyte). In this regard, when C and F as constituent elements contained in the coating layer 1b are derived from perfluoropolyether, a higher effect may be obtained.

The perfluoropolyether has a perfluoropolyether chain. For example, the perfluoropolyether may be one represented by the following formula (1):

E₁-Rf₁-R^{F}—O—Rf₂-E₂ (1)
[In Formula (1), Rf₁ and Rf₂ are each independently a C1-16 divalent alkylene group optionally substituted by one or more fluorine atoms,
E₁ and E₂ are each independently a single valence group selected from fluorine group, hydrogen group, aldehyde group, carboxyl group, C1-10 alkyl ester group, amide group optionally having one or more substituents, amino group optionally having one or more substituents,
R^{F} is a divalent fluoropolyether group.]

In the above formula (1), Rf₁ and Rf₂ are each independently a C1-16 divalent alkylene group optionally substituted by one or more fluorine atoms. In one embodiment, the “C1-16 divalent alkylene group” described above may be straight or branched, and is a straight or branched C1-6 alkylene group, particularly a C1-3 alkylene group, or a straight alkylene group, particularly a C1-3 alkylene group. In one embodiment, the “C1-16 divalent alkylene” described above may be straight or branched, and is a straight or branched C1-6 fluoroalkylene group, particularly a C1-3 fluoroalkylene group, and specifically may be —CF₂CH₂— or —CF₂CF₂CH₂—, or a straight C1-6 perfluoroalkylene group, particularly a C1-3 perfluoroalkylene group, and specifically may be a group selected from the group consisting of —CF₂—, —CF₂CF₂— and —CF₂CF₂CF₂—.

In the above formula (1), E₁ and E₂ are each independently, a monovalent group selected from a fluorine group, a hydrogen group, a hydroxyl group, an aldehyde group, a carboxyl group, a C1-10 alkyl ester group, an amido group optionally having one or more substituents, and an amino group optionally having one or more substituents. As described above, the perfluoropolyether has low reactivity to a sulfide solid electrolyte described later. Therefore, even when the perfluoropolyether and the sulfide solid electrolyte come into contact with each other, deterioration of ion conductivity due to deterioration of the sulfide solid electrolyte hardly occurs. In particular, when the perfluoropolyether is one having a non-polar group as a terminal group, the reaction between the perfluoropolyether and the sulfide solid electrolyte is further suppressed, and a further high effect can be expected. In this regard, each of the above E₁ and E₂ may be independently a fluorine-containing group. In one embodiment, E₁-Rf₁ and E₂-Rf₂ may be independently a group selected from —CF₃, —CF₂CF₃, and —CF₂CF₂CF₃.

In the above formula (1), R^{F} is each independently a divalent fluoropolyether group at each occurrence. In some embodiments, R^{F} is the group represented by the following Formula (2):

—(OC₆F₁₂)ₐ—(OC₅F₁₀)_{b}—(OC₄F₈)_{c}—(OC₃R^{Fa}₆)_{d}—(OC₂F₄)₃—(OCF₂_{f}— (2)
[In Formula (2):
R^{Fa} is each independently a hydrogen atom, a fluorine atom or a chlorine atom at each occurrence,
a, b, c, d, e and f are each independently an integer from 0 to 200,
the sum of a, b, c, d, e and f is equal to or greater than 1,
the order of presence of each repeating unit bracketed with a, b, c, d, e or f is arbitrary in the formula,
however, when all of R^{Fa} are hydrogen atoms or chlorine atoms, at least one of a, b, c, e and f is 1 or more.]
   In some embodiments, R^{Fa} is a hydrogen atom or a fluorine atom, or a fluorine atom. In some embodiments, a, b, c, d, e and f may be each independently be an integer from 0 to 100. In some embodiments, the sum of a, b, c, d, e and f is 5 or more, or 10 or more, and may be, for example, 15 or more or 20 or more. In some embodiments, the sum of a, b, c, d, e and f is 200 or less, 100 or less, or 60 or less, and may be, for example, 50 or less or 30 or less.

These repeating units may be linear or branched. In some embodiments, in R^{F}, the ratio of d to f (hereinafter referred to as “d/f ratio”) may be 0.5 to 4, 0.6 to 3, 0.7 to 2, or 0.8 to 1.4. By setting d/f ratio to 4 or less, lubricity and chemical stability are further improved. The smaller d/f ratio, the better the lubricity. On the other hand, by setting d/f ratio to 0.5 or more, the stability of the compound can be further increased. The greater d/f ratio, the better the stabilities of the fluoropolyether structure. In some embodiments, in this case, the value of f is 0.8 or more. In some embodiments, in the above, the number-average molecular weight of R^{F} portion is not particularly limited, but is, for example, 500 to 30,000, 1,500 to 30,000, or 2,000 to 10,000. In the present application, the number-average molecular weight of R^{F} is a value measured by ¹⁹F-NMR.

### 1.2.4 Elemental Ratio

By having the coating layer 1b described above, the active material composite 1 may be provided with, for example, the following configuration. That is, when the surface of the active material composite 1 is analyzed by XPS, the element ratio Li/P of Li and P may be, for example, 0 or more and 1.40 or less, 0.80 or more and 1.40 or less, or 0.90 or more and 1.30 or less. In addition, when the surface of the active material composite 1 is analyzed by XPS, the element ratio B/P of B and P may be, for example, 0 or more and 10 or less, or 0 or more and 1 or less. In addition, when the surface of the active material complex 1 is analyzed by XPS, the element ratio F/P of F and P may be, for example, 0.05 or more and 2.00 or less, or 0.10 or more and 1.60 or less.

### 1.2.5 Coverage

The coverage of the coating layer 1b on the surface of the active material particle 1a is not particularly limited. The coating layer 1b may cover 70% or more and 100% or less, 90% or more and 100% or less, or 95% or more and 100% or less of the surface of the active material particle 1a. Note that the coverage ratio (area ratio) of the coating layer 1b on the surface of the active material particle 1a can be calculated by observing a scanning electron microscopy (SEM) image or the like of a cross section of the active material composite. Alternatively, it can also be calculated by measuring the element ratio of the surface by X-ray photoelectric spectroscopy (XPS).

### 1.2.6 Thickness

The thickness of the coating layer 1b is not particularly limited, and may be, for example, 0.1 nm or more and 500 nm or less. Lower limit may be 0.5 nm or more, 1 nm or more or 10 nm or more, and the upper limit may be 300 nm or less, 100 nm or less, 50 nm or less, or 30 nm or less. Note that the thickness of the coating layer 1b on the surface of the active material particle 1a can be specified, for example, by observing a cross section of the active material composite by scanning electron microscopy (SEM) or the like.

### 1.2.7 Other

C and F as the constituent elements described above may be present inside the coating layer 1b, or may be present on the surface of the coating layer 1b, or may be present both inside and on the surface of the coating layer 1b. In particular, when the coating layer 1b contains C or F as a constituent element at least inside thereof, higher performance may be obtained. In addition, the coating layer 1b may contain an impurity or the like derived from a raw material. For example, the coating layer 1b may contain Na as a constituent element. Na may be included as an excipient in phosphoric acid. Also, Na may react with F described above. In other words, the coating layer 1b may contain NaF

### 2. Method for Producing Active Material Composite

The active material composite 1 of the present disclosure can be produced, for example, by contacting a predetermined coating liquid with a surface of the active material particle 1a, and then drying the coating liquid. For example, as in the first embodiment or the second embodiment described below. In the following description, a method of gas-flow drying the slurry droplets is exemplified, but the active material composite of the present disclosure can also be manufactured by a method other than this.

### 2.1 First embodiment

As shown in FIGS. 2A and 2B, a method for producing an active material composite according to the first embodiment may comprise,
Step S1-1: dropletizing a slurry 1c containing an active material particle 1a and a coating liquid 1bx to obtain a slurry droplet 1d, and
Step S1-2: gas-flow drying the slurry droplet 1d in a heated gas to form a coating layer 1b on the surface of the active material particle 1a to obtain an active material composite 1.

Here, the coating liquid 1bx used in the first embodiment may include a phosphoric acid compound and a C and F source.

### 2.1.1 Step S1-1

In the step S1-1, a slurry 1c containing an active material particle 1a and a coating liquid 1bx is dropletized to obtain a slurry droplet 1d. The “slurry” may be any suspension containing an active material particle 1a and a coating liquid 1bx and having a fluidity enough to be dropletized. The active material particle 1a contained in the slurry is as described above. The coating liquid 1bx constituting the slurry includes, for example, a phosphoric acid compound and a C and F source. The phosphoric acid compound may be, for example, a compound containing Li, P and O, or a compound containing B, P and O, or a compound containing Li, B, P and O, as described above. The C and F source may be, for example, a compound such as perfluoropolyethers, as described above. The concentration of each of the phosphoric acid compound and the C and F source contained in the coating liquid 1bx is not particularly limited and may be appropriately adjusted according to the composition of the coating layer 1b. The solvents constituting the coating liquid 1bx may be, for example, water. The solid concentration of the slurry is not particularly limited. In addition to the active material particle 1a and the coating liquid 1bx described above, the slurry may contain some solid component or liquid component.

In the step S1-1, the above slurry 1c is dropletized. “Dropletizing” of the slurry means that the slurry 1a containing the active material particles and the coating liquid 1bx is made into a particle containing the active material particles 1c and the coating liquid 1bx. There is no particular limitation on the manner in which the slurry 1c containing the active material particle la and the coating liquid 1bx is dropletized. Examples thereof include a method of making a liquid droplet by spraying a slurry 1c. When a slurry 1c is sprayed, a spray nozzle may be used. Examples of a method of spraying a slurry 1c using a spray nozzle include, but are not limited to, a pressurizing nozzle method and a two fluid nozzle method. Alternatively, the slurry 1c may be dropletized using a rotary atomizer.

The slurry droplet Id is obtained by the step S1-1. The “slurry droplet” is a particle of a slurry 1c containing the active material particle 1a and the coating liquid 1bx. The number of active material particle 1a contained in the slurry droplet Id is not particularly limited. In addition, the size of the slurry droplet Id is not particularly limited. The diameter (sphere equivalent diameter) of the slurry droplet Id may be, for example, 0.5 μm or more or 5 μm or more, and may be 5000 μm or less or 1000 μm or less. The diameter of the slurry droplet 1d can be measured using, for example, a two dimensional image obtained by imaging a slurry droplet 1d, or can be measured using a particle size distribution of a laser diffractometer. Alternatively, the droplet size can be estimated from the operating conditions of the device forming the slurry droplet 1d.

### 2.1.2 Step S1-2

In the step S1-2, the slurry droplet Id is gas-flow dried in a heated gas to form a coating layer 1b on the surface of the active material particle 1a and to obtain an active material composite 1. “Gas-flow drying” means drying the slurry droplet 1d while floating in a high temperature gas stream. “Gas-flow drying” may include not only drying but also ancillary operation by using a dynamic gas-flow. By continuing to apply hot gas to the slurry droplet 1d by gas-flow drying, the force will continue to be applied to the slurry droplet 1d. Taking advantage of this, for example, the step S1-2 may include disintegrating aggregations of the slurry droplet 1d (or agglomerates of the active material composite 1) by gas-flow drying. In other words, in the step S1-2, even when the granulated body of the slurry droplet 1d or the active material composite 1 is generated, the granulated body can be crushed by gas-flow drying. Therefore, it is also possible to use a slurry having a low solid concentration, and it is easy to increase the processing speed. Thus, in the step S1-2, by crushing the slurry droplet 1d or the like by gas-flow drying, it is easy to shorten the manufacturing time. In addition, it is easy to produce an active material composite 1 having high performance. In the step S1-2, the above-described drying and crushing may be performed simultaneously or may be performed separately. In the step S1-2, the first gas-flow drying in which the drying of the slurry droplet Id becomes dominant, and the second gas-flow drying in which the crushing of the active material composite 1 becomes dominant may be performed. Further, the second step may be repeated.

In the step S1-2, the temperature of the heating gas, the amount of the heating gas supplied (flow rate), the feed rate of the heating gas (flow velocity), and the treatment time (drying time) by the heating gas can be appropriately set in view of the size of the device used, the form of the slurry droplet 1d, and the like. For example, conditions such as those disclosed in JP 2022-047501 A may be employed. In the step S1-2, a heated gas which is substantially inert to the active material particle 1a and the coating liquid 1bx may be used. For example, an oxygen containing gas such as air, an inert gas such as nitrogen or argon, a dry air having a low dew point, or the like can be used. The dew point in that case may be −10° C. or less, −50° C. or less, or −70° C. or less. As an apparatus for performing gas-flow drying, for example, a spray dryer may be used, but is not limited thereto.

### 2.1.3 Other Processes

After the gas-flow drying described above, firing may be optionally performed. As the firing apparatus, for example, a muffle furnace, a hot plate, or the like can be used, but is not limited thereto. The condition of firing is not particularly limited and can be appropriately set according to the type of the active material composite 1.

### 2.2 Second Embodiment

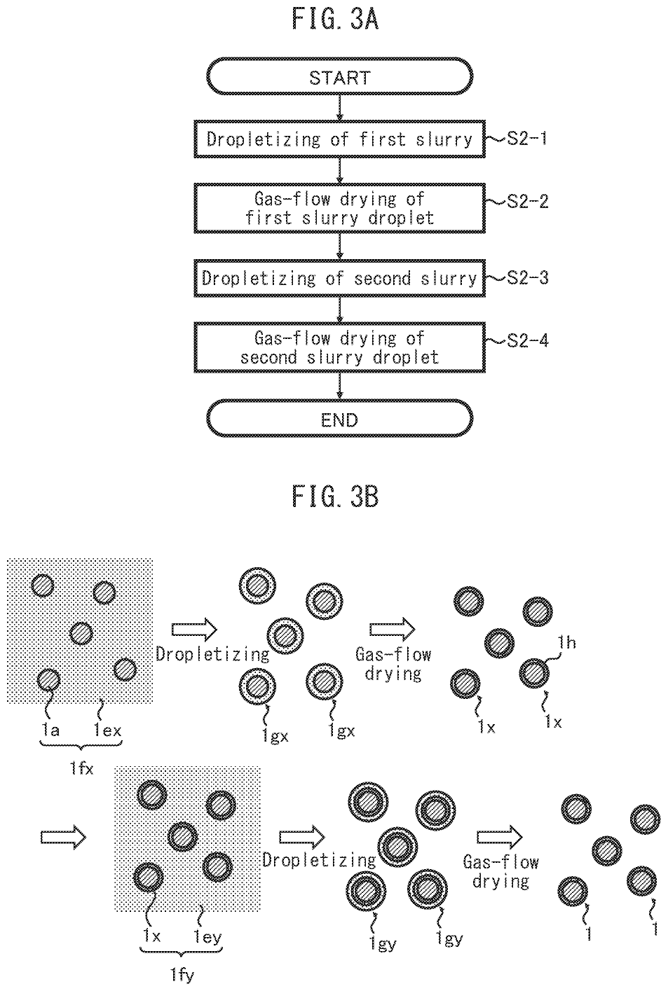

As shown in FIG. 3A and 3B, a method for producing the active material composite according to a second embodiment may comprise,
Step S2-1: dropletizing a first slurry 1fx containing an active material particle 1a and a first coating liquid 1ex to obtain a slurry droplet 1gx,
Step S2-2: gas-flow drying the first slurry droplet 1gx in a heated gas to form a first coating layer 1h on the surface of the active material particle 1a to obtain an intermediate composite 1x,
Step S2-3: dropletizing a second slurry 1fy containing the intermediate complex 1xand a second coating liquid ley to obtain a second slurry droplet 1gy, and
Step S2-4: gas-flow drying the second slurry droplet 1gy in a heated gas to form a coating layer 1b on the surface of the intermediate complex 1x (or the active material particle 1a) to obtain an active material composite 1.

Here, the first coating liquid 1ex may be one containing at least a phosphoric acid compound and no C and F source. In addition, the second coating liquid ley may include at least C and F source. The “phosphoric acid compound” and the “C and F source” are as described above.

In the second embodiment, a first coating layer 1h containing a phosphoric acid compound is formed on the surface of the active material particle 1a to obtain an intermediate composite 1x, and then a second coating layer containing C and F is further formed (or C and F are introduced into the first coating layer 1h) on the intermediate composite 1x. In the second embodiment, the first coating liquid 1ex and the second coating liquid ley are used to perform the dropletizing of the slurry and the gas-flow drying of the slurry droplets in two stages. The conditions of the dropletizing in the steps S2-1 and S2-3 and the conditions of the gas-flow drying in the steps S2-2 and S2-4 may be the same as those of the condition according to the above-described first embodiment except that the type of the coating liquid is different. For example, conditions such as those disclosed in JP 2022-047501 A may be adopted.

### 3. Secondary Battery

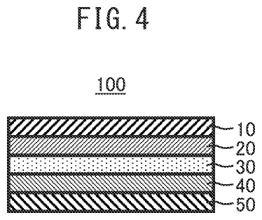

FIG. 4 schematically shows the configuration of a secondary battery 100 according to an embodiment. As shown in FIG. 4, the secondary battery 100 has a positive electrode active material layer 20, an electrolyte layer 30, and a negative electrode active material layer 40, and the positive electrode active material layer 20 includes the above-described active material composite 1. Further, a problem relating to durability of the active material composite 1 is more likely to be manifested when the secondary battery 100 includes a solid electrolyte. In this regard, in the secondary battery 100, at least one of the positive electrode active material layer 20, the electrolyte layer 30, and the negative electrode active material layer 40 may include a solid electrolyte. In particular, in the secondary battery 100, when at least the positive electrode active material layer 20 includes an inorganic solid electrolyte, among them, when at least the positive electrode active material layer 20 includes a sulfide solid electrolyte, a higher effect may be obtained. In the secondary battery 100, the positive electrode active material layer 20, the electrolyte layer 30, and the negative electrode active material layer 40 may contain a sulfide solid electrolyte.

The sulfide solid electrolyte may be a glass-based sulfide solid electrolyte (sulfide glass), a glass ceramic-based sulfide solid electrolyte, or a crystal-based sulfide solid electrolyte. When the sulfide solid electrolyte has a crystalline phase, examples of the crystalline phase include a Thio-LISICON type crystalline phase, a LGPS type crystalline phase, and an aldilodite type crystalline phase. The sulfide solid electrolyte may contain, for example, Li element, X element (X is at least one of P, As, Sb, Si, Ge, Sn, B, Al, Ga, and In), and S element. Further, the sulfide solid electrolyte may further contain at least one of an O element and a halogen element. Further, the sulfide solid electrolyte may be one containing an S element as a main component of an anionic element. The composition of sulfide solid electrolyte is not particularly limited, for example, xLi₂S·(100−x)P₂S₅ (70≤x≤80), yLiI·zLiBr·(100−y−z)(xLi₂S·(1−x)P₂S₅) (0.7≤x≤0.8, 0≤y≤30, 0≤z≤30) and the like. Alternatively, the sulfide solid electrolyte may have the composition represented by the general formula: Li₄₋ₓGe₁₋ₓPₓS₄ (0<x<1). In the above general formula, at least a portion of Ge may be substituted with at least one of Sb, Si, Sn, B, Al, Ga, In, Ti, Zr, V and Nb. In the above general formula, at least a portion of P may be substituted with at least one of Sb, Si, Sn, B, Al, Ga, In, Ti, Zr, V and Nb. In the above general formula, a part of Li may be substituted with at least one of Na, K, Mg, Ca and Zn. In the above general formula, a portion of S may be substituted with halogen (at least one of F, Cl, Br and I). Alternatively, the solid electrolyte may have a composition represented by Li₇₋ₐPS₆₋ₐXₐ (X is at least one of Cl, Br and I, and a is a number of 0 or more and 2 or less). “a” may be 0 and may be greater than 0. In the latter case, “a” may be 0.1 or more, 0.5 or more, or 1 or more. Further, “a” may be 1.8 or less, or 1.5 or less.

The secondary battery 100 may be a solid-state battery. The solid-state battery refers to one in which an electrolyte having carrier ion conductivity is mainly constituted by a solid electrolyte. However, a part thereof may contain a liquid component. Alternatively, the secondary battery 100 may be an all-solid-state battery substantially free of liquid components. Further, as shown in FIG. 4, the secondary battery 100 may include a positive electrode current collector 10 in contact with the positive electrode active material layer 20. Further, the secondary battery 100 may include a negative electrode current collector 50 in contact with the negative electrode active material layer 40. The secondary battery 100 can be manufactured by, for example, a method as disclosed in JP 2022-047501 A or the like, except that the active material composite 1 described above is contained in the positive electrode active material layer 20.

### EXAMPLES

Hereinafter, the technique of the present disclosure will be described in further detail with reference to Examples, but the technique of the present disclosure is not limited to the following Examples.

### 1. Preparation of the Coating Liquid

### 1.1 Comparative Example 1

Metaphosphoric acid (manufactured by Fujifilm Wako Pure Chemical Industries, Ltd.) 10.8 g was dissolved in ion-exchanged water 166.0 g. Thereafter, a coating liquid according to Comparative Example 1 was obtained by adding lithium hydroxide monohydrate so that Li/P (molar ratio) became 0.45.

### 1.2 Example 1

Metaphosphoric acid (manufactured by Fujifilm Wako Pure Chemical Industries, Ltd.) 10.8 g was dissolved in ion-exchanged water 166.0 g. Thereafter, lithium hydroxide monohydrate was added so that Li/P (molar ratio) was 0.45 to obtain an aqueous solution. Further, perfluoropolyether (PFPE) was added so as to be 5% by mass based on the aqueous solution to obtain a coating liquid according to Example 1. In the Example, the perfluoropolyether has the following chemical structure.

R¹—O(CF₂CF₂CF₂O)ₙ—R²
where R¹ and R² are each —CF₃.

### 1.3 Example 2

Metaphosphoric acid (manufactured by Fujifilm Wako Pure Chemical Industries, Ltd.) 10.8 g was dissolved in ion-exchanged water 166.0 g Thereafter, lithium hydroxide monohydrate was added so that Li/P (molar ratio) was 0.45 to obtain an aqueous solution. Further, perfluoropolyether was added so as to be 10% by mass based on the aqueous solution to obtain a coating liquid according to Example 2

### 1.4 Comparative Example 2

Metaphosphoric acid (manufactured by Fujifilm Wako Pure Chemical Industries, Ltd.) 10.8 g was dissolved in ion-exchanged water 166.0 g Thereafter, Boric Acid (manufactured by Nacalai Tesque Co., Ltd.) was added so that B/P (molar ratio) became 1.00 to obtain a coating liquid according to Comparative Example 2

### 1.5 Example 3

As the coating liquid for the first layer (first coating liquid), the same as in Comparative Example 2 was used. As the coating liquid for the second layer (second coating liquid), the one having an ion-exchanged water and a perfluoropolyether in which the perfluoropolyether 0.1 g was dispersed per 10 g of the water.

### 1.6 Example 4

As the coating liquid for the first layer (first coating liquid), the same as in Comparative Example 2 was used. As the coating liquid of the second layer (second coating liquid), the one having an ion-exchanged water and a perfluoropolyether in which the perfluoropolyether 0.5 g was dispersed per 10 g of the water.

### 1.7 Example 5

Metaphosphoric acid (manufactured by Fujifilm Wako Pure Chemical Industries, Ltd.) 10.8 g was dissolved in ion-exchanged water 166.0 g. Thereafter, boric acid (manufactured by Nacalai Tesque Co., Ltd.) was added so that B/P (molar ratio) became 1.00 to obtain an aqueous solution. Further, perfluoropolyether was added so as to be 5% by mass with respect to the aqueous solution, thereby obtaining a coating liquid according to Example 5.

### 1.8 Comparative Example 3

Metaphosphoric acid (manufactured by Fujifilm Wako Pure Chemical Industries, Ltd.) 10.8 g was dissolved in ion-exchanged water 166.0 g. Thereafter, Boric Acid (manufactured by Nacalai Tesque Co., Ltd.) was added so that B/P (molar ratio) was 1.00. Further, a coating liquid according to Comparative Example 3 was obtained by adding lithium hydroxide monohydrate so that Li/(P+B) (molar ratio) was 0.50.

### 1.9 Example 6

The coating liquid according to Example 6 was obtained by adding perfluoropolyether to the coating liquid according to Comparative Example 3 so as to be 5% by mass.

### 2. Preparation of the Active Material Composite

### 2.1 Examples 1, 2, 5, and 6 and Comparative Examples 1, 2, and 3

For LiNi_{1/3}Mn_{1/3}Co_{1/3}O₂ particle as active material particle (manufactured by Nichia Chemicals Co., Ltd.) 50 g, by adding the above-mentioned 22 g of the coating liquid to produce a slurry. Using a liquid feed pump, the slurry was supplied to a spray dryer (manufactured by Buchh Co., Ltd., mini spray dryer B-290) to dropletize the slurry (Step S1-1) and gas-flow drying of the slurry droplets (Step S1-2) to obtain an active material composite. The feed gas temperature in spray drying was 200° C., the feed gas volume was 0. 45 m³/min, and the feed rate was 0.5 g/sec.

### 2.2 Examples 3, 4

For LiNi_{1/3}Mn_{1/3}Co_{1/3}O₂ particle as an active material particle (manufactured by Nichia Chemicals Co., Ltd.) 50 g, by adding the above-mentioned first coating liquid 22 g to produce a first slurry. Using a liquid feed pump, the first slurry was supplied to a spray dryer (manufactured by Buchh Co., Ltd., mini spray dryer B-290) to dropletize the first slurry (step S2-1) and gas-flow drying of the first slurry droplets (step S2-2) to obtain an intermediate composite. The feed gas temperature in spray drying was 200° C., the feed gas volume was 0. 45 m³/min, and the feed rate was 0.5 g/sec.

The second coating liquid 18 g described above was added to the resulting intermediate composite 40 g to prepare a second slurry. Using a liquid feed pump, the second slurry was supplied to a spray dryer (manufactured by Buchh Co., Ltd., mini spray dryer B-290), and dropletizing of the second slurry (step S2-3), and gas-flow drying of the second slurry droplets (step S2-4) was performed to obtain an active material composite. The feed gas temperature in spray drying was 200° C., the feed gas volume was 0.45 m³/min, and the feed rate was 0.5 g/sec.

### 3. Analysis of the Active Material Complex

Surface-element analyses of the active material composites described above were performed by X-ray photoelectron spectroscopy (XPS: PHI X-tool manufactured by ULVAC-FIE). The pass energy was 224 eV, and narrow scan analyses were performed. Elemental ratios such as Li/P and F/P were calculated from the respective intensities of the detected Li1s, C1s, O1s, F1s, P1s, Mn2p3, Co2p3, Ni2p3 by the analysis software MultiPak (ULVAC-FIE). The presence or absence of peaks derived from CFx was also confirmed.

Further, the appearance observation and the cross-sectional observation of the active material composite described above were performed to confirm the coverage ratio and the thickness of the coating layer in the active material composite. As a result, coating layers of the examples and comparative examples had a coverage ratio of almost 100% and a thickness of about 20 nm.

### 4. Fabrication and Evaluation of Batteries

### 4.1 Preparation of the Positive Electrode

The active material composites of each of the examples and comparative examples and the sulfide solid electrolyte (10LiI-15LiBr-37.5Li₃PS₄) were weighed so as to have a volume ratio of 6:4, and these were charged into heptane together with 3% by mass of a vapor grown carbon fiber (VGCF) (manufactured by Showa Denko Co., Ltd.) as a conductive aid and 0.7% by mass of butadiene rubber (manufactured by JSR Co., Ltd.) as a binder. Then, a positive electrode mixture was prepared by mixing them. The prepared positive electrode mixture was sufficiently dispersed by an ultrasonic homogenizer, and then coated on an aluminum foil and dried at 100° C. for 30 minutes. Thereafter, the positive electrode according to the respective examples and comparative examples was obtained by punching to the size of 1 cm².

### 4.2 Preparation of the Negative Electrode

A negative electrode active material (layered carbon) and a sulfide solid electrolyte (10LiI-15LiBr-37.5Li₃PS₄) were prepared so as to have a volume ratio of 6:4, and these were charged into heptane together with 1.2% by mass of butadiene rubber (manufactured by JSR Co., Ltd.) as a binder. Then, a negative electrode mixture was prepared by mixing them. The prepared negative electrode mixture was sufficiently dispersed by an ultrasonic homogenizer, and then coated on a copper foil and dried at 100° C. for 30 minutes. Afterwards, negative electrodes were obtained by punching to the size of 1 cm².

### 4.3 Preparation of the Solid Electrolyte Layer

Sulfide solid-electrolyte (10LiI-15LiBr-37.5Li₃PS₄) 64.8 mg were placed in a ceramic cylinder with an internal cross-sectional area of 1 cm², smoothed, and then pressed at 1 ton to form a solid-electrolyte layer.

### 4.4 Fabrication of the battery

The positive electrode prepared above was superimposed on one side of the solid-electrolyte layer, and the negative electrode prepared above was superimposed on the other side and pressed for 1 minutes at 4.3 ton. Then, a stainless-steel bar was placed in both electrodes and constrained at 1 ton to obtain lithium-ion secondary batteries according to the respective Examples and Comparative Examples.

### 4.5 Endurance Test

For lithium-ion secondary battery prepared as described above, it was carried out cycle test (voltage-range 2.5V-4.4V, 100 cycles) in 60° C. constant temperature bath. Resistance was measured by 3.66V before and after the cycling test, and the resistance increasing rate was calculated.

### 5. Results

The evaluation results are shown in Table 1 below.

TABLE 1

| | Surface property of active material composite measured by XPS | | | | | Battery evaluation | |
|---|---|---|---|---|---|---|---|
| | Phosphoric | Li/P | F/P | Presence | Presence | Initial | Resistance |
| | acid | (molar | (molar | of | of | resistance | increasing |
| | compound | ratio) | ratio) | NaF | CFₓ peak | (Ω) | rate |
| Comp. | LPO | 1.42 | 0 | absence | absence | 20.3 | 54% |
| Ex. 1 | | | | | | | |
| Ex. 1 | LPO | 1.17 | 1.01 | presence | presence | 15.2 | 40% |
| Ex. 2 | LPO | 0.98 | 1.59 | presence | presence | 15.3 | 46% |
| Comp. | BPO | 1.10 | 0 | absence | absence | 8.9 | 25% |
| Ex. 2 | | | | | | | |
| Ex. 3 | BPO | 1.15 | 0.14 | absence | presence | 9.1 | 21% |
| Ex. 4 | BPO | 1.23 | 0.37 | absence | presence | 9.3 | 20% |
| Ex. 5 | BPO | 1.23 | 0.39 | presence | presence | 9.2 | 22% |
| Comp. | LBPO | 1.19 | 0 | absence | absence | 9.0 | 21% |
| Ex. 3 | | | | | | | |
| Ex. 6 | LBPO | 1.14 | 0.39 | presence | presence | 9.5 | 15% |

As is apparent from the results shown in Table 1, it can be said that the coating layer of the active material composite according to Examples 1 to 6 contains a phosphoric acid compound and has C and F introduced into its surface and/or inside. On the other hand, it can be said that the coating layer of the active material composite according to Comparative Examples 1 to 3 contains a phosphoric acid compound and does not contain C and F. As is apparent from the results shown in Table 1, it can be seen that the active material composites according to Examples 1 to 6 have a smaller resistance increase rate after the cycle test and durability than the active material composites according to Comparative Examples 1 to 3. It is considered that when the coating layer of the active material composite contains C and F together with the phosphoric acid compound, the coating layer hardly decomposes even at a high potential, and this leads to an improvement in durability. It is to be noted that, for some of the embodiments, the presence of NaF was confirmed by XPS, but this is considered to be that Na contained as an excipient in phosphoric acid reacted with F.

In the above examples, the positive electrode active material particles having a specific composition are exemplified, but the composition of the active material particles is not limited thereto. In addition, in the above embodiment, LPO, BPO and LBPO are exemplified as the phosphoric acid compound, but the type of the phosphoric acid compound is not limited thereto. However, it is considered that when the coating layer contains at least one of LPO, BPO and LBPO, a higher effect is obtained. In addition, in the above examples, perfluoropolyether is exemplified as the C and F source, but the type of the C and F source is not limited thereto.

However, when C and F contained in the coating layer are those derived from perfluoropolyether, it is considered that a higher effect is obtained.

From the above results, it can be said that the active material composite comprising the following configurations (1) to (4) has durability after the cycle test.
(1) The active material composite has an active material particle and a coating layer.
(2) The coating layer covers at least a part of the surface of the active material particle.
(3) The coating layer includes a phosphoric acid compound.
(4) Elements constituting the coating layer include C and F.

### REFERENCE SIGNS LIST

1 Active material composite
1a Active material particles
1b Coating layer
100 Secondary battery
10 Positive electrode current collector
20 Positive electrode active material layer
30 Electrolyte layer
40 Negative electrode active material layer
50 Negative electrode current collector

1. An active material composite comprising an active material particle and a coating layer, wherein
the coating layer covers at least a portion of a surface of the active material particle,
the coating layer comprises a phosphoric acid compound, and
elements constituting the coating layer comprise C and F.

2. The active material composite according to claim 1, wherein
the phosphoric acid compound comprises one or both of Li and B.

3. The active material composite according to claim 1, wherein
the coating layer comprises a C—F bond.

4. The active material composite according to claim 1, wherein
the coating layer comprises NaF.

5. A secondary battery comprising: a positive electrode active material layer, an electrolyte layer and a negative electrode active material layer, wherein
the positive electrode active material layer comprises the active material composite according to claim 1.
